(19) United States
(12) Patent Application Publication
(10) Pub. No.: US 2004/0107839 A1
(43) Pub. Date: Jun. 10, 2004

(54) Method of serving heated beverages

(75) Inventor: Hiroshi Furumichi, Tokyo (JP)

Correspondence Address: HOWREY SIMON ARNOLD & WHITE LLP, BOX 34, 1299 PENNSYLVANIA AVENUE NW, WASHINGTON, DC, 20004, US

(73) Assignee: The Coca-Cola Company

(21) Appl. No.: 10/457,424

(22) Filed: Jun. 10, 2003

(30) Foreign Application Priority Data
Dec. 6, 2002 (JP) 2002-171443

(51) Int. Cl. A23L 1/00

(52) U.S. Cl. 99/275

(57) ABSTRACT

The objective of the invention is to minimize the deformation of the plastic container filled with beverage that is to be heated to be served. A non-carbonated beverage is filled in a plastic container at a normal temperature. The head space of the plastic container filled with the non-carbonated beverage is injected with carbon dioxide gas to replace a portion of the air in the head space. The container in which a portion of the air in the head space has been replaced with carbon dioxide is sealed with a cap at its mouth. The beverage sealed inside the plastic container is heated to be served to consumers.

### CROSS-REFERENCE TO RELATED APPLICATION

This application claims priority to Japanese patent application number JP2002-171443, filed Jun. 12, 2002.

### FIELD OF THE INVENTION

The present invention relates to a method of serving a beverage contained in a plastic container by heating the same to, for example, 45- 90 degrees Celsius.

### BACKGROUND OF THE INVENTION

It is a wide practice to fill beverages in plastic container and heat the same in automatic vending machines, warming devices or the like before serving the same to consumers.

Conventionally, beverages are filled in plastic containers at a relatively high temperatures and are heated before they are served to consumers. If beverages are filled in plastic containers at a high temperature, the pressure inside the containers will decrease at normal temperatures. As such, the pressure inside the containers will not rise too much even when the beverages are heated, and deformation of the containers was avoided.

In order not to impair the flavor of the beverage and the like reasons, it has also been the practice to fill beverages in containers under s terile conditions at a normal temperature.

A problem has arisen anew , however, because in case beverages are filled in plastic containers at normal temperatures, containers would become deformed as the pressure therein will rise as a result of expansion of gas in the head space when the beverages are heated before served to consumers.

### SUMMARY OF THE INVENTION

In order to solve the problem mentioned above, the present invention provides a method of serving heated beverages, which is characterized by the steps of:

filling a non-carbonated beverage in a plastic container at a normal temperature,

injecting carbon dioxide gas into the headspace of the plastic container filled with the non-carbonated beverage to replace a portion of the air inside the head space,

capping the mouth of the plastic container in which a portion of the air inside the head space has been replaced with carbon dioxide, and

serving the beverage sealed inside the plastic container to consumers by heating the same.

### DESCRIPTION OF THE DRAWINGS

FIG. 1 shows the chronological changes in the bottom dimension of the plastic containers.

FIG. 2 shows the chronological changes in the girth of the plastic containers.

FIG. 3 shows the chronological changes in the total height of the plastic containers.

### DETAILED DESCRIPTION OF THE INVENTION

A thermo-plastic resin such as polyethylene, polypropylene, and polyethylene terephthalate is subjected to blow molding, injection blow molding, stretch blow molding or the like to produce plastic containers to be used in the present invention. Plastic containers thus produced and caps are subjected to sterilization treatment using hot water or chlorine-base bactericide and fed to sterile filling device.

Beverages to be filled include non-carbonated beverages such as green tea, Oolong tea, black tea, milk tea, black coffee, milk coffee, and fruit juices.

A non-carbonated beverage is filled in a plastic container using known sterile filling device in a sterile air atmosphere at 5- 40 degrees Celsius, more preferably at a normal temperature between 15- 35 degrees Celsius.

In the head space of the plastic container filled with non-carbonated beverage is injected carbon dioxide gas, or a gas mixture containing carbon dioxide and nitrogen gas and the container is sealed with a cap. Thus, the air inside the head space is replaced with carbon dioxide gas. Preferably, 30- 60% of the air in the head space is replaced with carbon dioxide gas. The air in the head space, particularly oxygen, is preferably replaced with as much carbon dioxide as possible in order to prevent oxidation of the contents in the container. The amount of oxygen content is preferably less than 1 mg/100 ml.

After replacement with carbon dioxide is complete, the plastic container is sealed with a cap, transported outside the sterile filling device, and then supplied to retail shops via customary distribution route.

At retail shops, the containers are heated to 45-90 degrees Celsius, preferably to 50-60 degrees Celsius in an automatic vending machine with heating device, warmer apparatus, etc. to be served to consumers.

### EXAMPLE

Green tea, milk tea, and milk coffee were filled into 280 mol polyester bottles produced by Ishizuka Glass Co. using sterile filling line manufactured by Dainippon Printing Co. Ltd. Immediately before capping, carbon dioxide gas was injected from the mouth of the bottle to replace the air inside the head space of the product. As a control, nitrogen gas was used to replace the air inside the head space of the product under the same conditions.

| Filling conditions: | |
|---|---|
| Liquid temperature: | 25-30 degrees |
| Filling rate: | 600 bottles/minute |

TABLE 1

| | | Flow rate | Filling | Replacement | |
|---|---|---|---|---|---|
| | Replacement | of gas | amount | ratio | |
| Product | gas | (NI/Min) | (ml) | (%) | Mean |
| Milk | CO₂ | 185 | 283 | 30.6 | 32.0 |
| coffee | | | | 33.3 | |
| | N₂ | 230 | 283 | 54.3 | 54.2 |
| | | | | 54.1 | |
| Milk tea | CO₂ | 180 | 283 | 35.1 | 38.2 |
| | | | | 41.3 | |
| | N₂ | 230 | 283 | 57.3 | 57.0 |
| | | | | 56.6 | |
| Green tea | CO₂ | 185 | 283 | 46.2 | 45.6 |
| | | | | 45.0 | |
| | N₂ | 225 | 283 | 57.3 | 54.2 |
| | | | | 51.0 | |

TABLE 2

| | Flavor (As compared with Control product) | |
|---|---|---|
| Product | Immediately after production | 55° C. After 1 week |
| Milk coffee | No problem | No problem |
| Milk tea | No problem | No problem |
| Green tea | No problem | No problem |

Heat resistance test:

Bottles filled with green tea in accordance with Example were immersed in a hot bath at 85 degrees, and chronological changes in the bottom dimension, the girth and the total height were measured. The result is shown below.

TABLE 3

| | Changes in bottom | | Changes in girth | | Changes in total height | |
|---|---|---|---|---|---|---|
| | dimension (mm) | | (mm) | | (mm) | |
| Immersion | Replaced | Replaced | Replaced | Replaced | Replaced | Replaced |
| time (Minute) | with CO₂ | with N₂ | with CO₂ | with N₂ | with CO₂ | with N₂ |
| 0 | 0.00 | 0.00 | 0.00 | 0.00 | 0.00 | 0.00 |
| 1 | 0.10 | −0.01 | 0.11 | 0.54 | 0.06 | 0.13 |
| 3 | 0.10 | −0.11 | 0.23 | 1.04 | 0.17 | 0.38 |
| 5 | 0.08 | −0.23 | 0.30 | 1.42 | 0.25 | 0.62 |
| 7 | 0.06 | −0.39 | 0.40 | 1.86 | 0.35 | 0.98 |
| 10 | −0.03 | −0.75 | 0.82 | 2.50 | 0.53 | 1.66 |

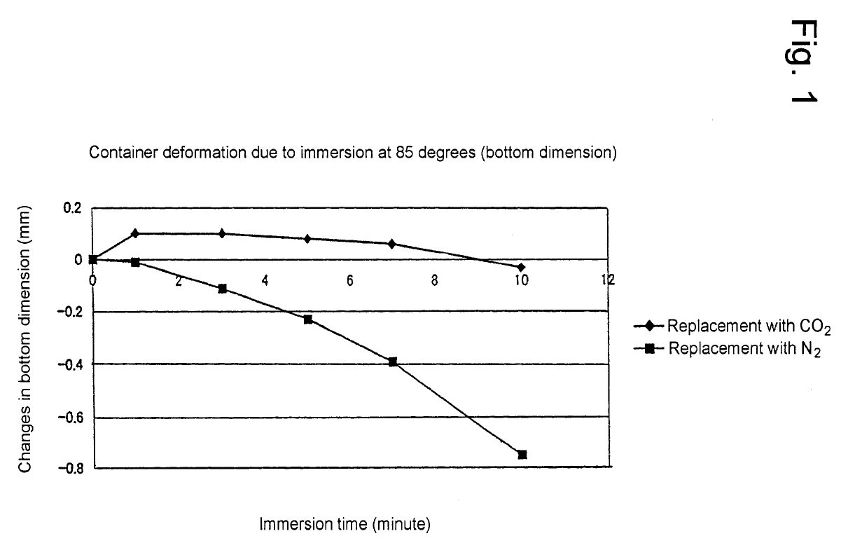

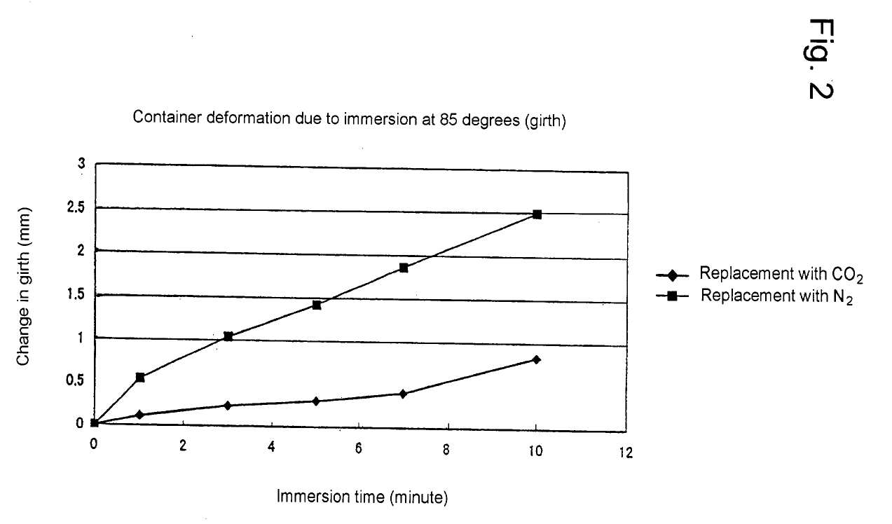

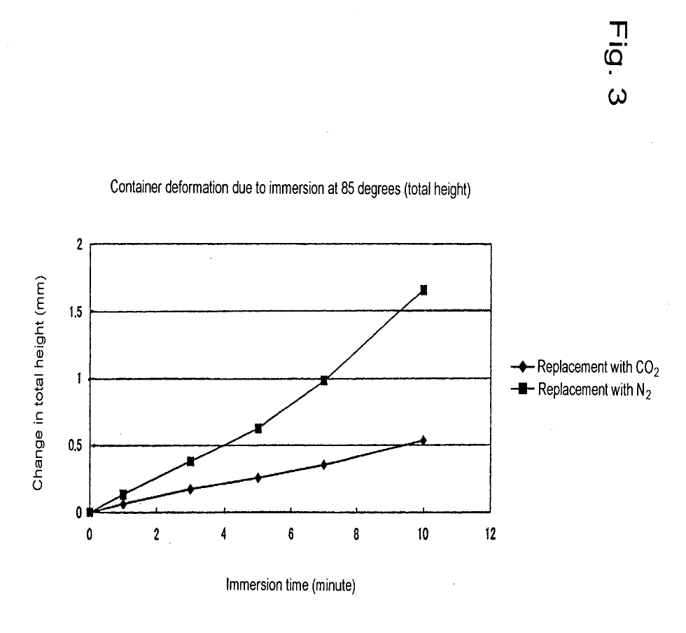

The chronological changes in the bottom dimension of the plastic containers are shown in FIG. 1; similar changes in the girth in FIG. 2 and changes in the total height in FIG. 3. The minus of changes in bottom means that the bottom has fallen below.

Effect:

Carbon dioxide gas is contained in the head space of the plastic container provided according to the present invention, and a portion of carbon dioxide has been dissolved in the beverage. The pressure inside the plastic container is decreased to below the atmospheric pressure. As a result, it becomes possible to minimize deformation of the container due to expansion of the gas inside the head space that is heated by heating mechanism built in the automatic vending machine, warmer device or the like.

I claim:

1. A method of serving heated beverage which is characterized by the steps of filling a plastic container with a non-carbonated beverage at a normal temperature, injecting carbon dioxide gas into the head space of the plastic container filled with non-carbonated beverage to replace a portion of the air in the head space with carbon dioxide gas, sealing with a cap the mouth of the container in which a portion of the air in the head space has been replaced with carbon dioxide, and heating the beverage sealed inside the plastic container to be served to the consumers.
